(19) United States
(12) Patent Application Publication
(10) Pub. No.: US 2024/0331224 A1
(43) Pub. Date: Oct. 3, 2024

(54) METHOD FOR GENERATING A REPROJECTION PANORAMIC VIEW ALIGNED WITH THE COURSE OF THE MANDIBULAR CANAL

(71) Applicants: DENTSPLY SIRONA Inc., York, PA (US); SIRONA DENTAL SYSTEMS GMBH, Bensheim (DE)

(72) Inventors: Marco BERTLEFF, Viernheim (DE); Kai STANNIGEL, Weinheim (DE)

(73) Assignee: DENTSPLY SIRONA Inc., York, PA (US)

(21) Appl. No.: 18/290,935

(22) PCT Filed: Jul. 11, 2022
(86) PCT No.: PCT/EP2022/069255

§ 371 Date: Jan. 22, 2024

(30) Foreign Application Priority Data
Jul. 23, 2021 (EP) 21187468.0
Dec. 2, 2021 (EP) 21211871.5

(51) Int. Cl. G06T 11/00; G06T 7/00

(52) U.S. Cl. CPC G06T 11/006; G06T 7/0012; G06T 2207/10116; G06T 2207/30036; G06T 2211/441

(57) ABSTRACT

The present invention relates to a method for automatically generating a reprojection panoramic view (RPV) from a dental DVT volume of a patient, which is aligned with the course of the mandibular canal, comprising the following steps; (S1) localization of the mandibular canal, (S2) automatic definition of a projection region of the RPV, which comprises the following sub steps: (S2.1) automatically setting a guide curve in a plane perpendicular to the patient longitudinal axis using the localized mandibular canal; (S2.2) automatically defining a variable or constant thickness profile along the guide curve; (S2.3) Extruding the area defined by guide curve and thickness profile along the patient longitudinal axis; and (S3) generating the RPV by reprojecting the DVT volume in the defined projection region.

The entire contents of the priority applications EP21187468.0 and EP 21211871.5 are hereby incorporated by reference to this international application under the provisions of the PCT.

### TECHNICAL FIELD OF THE INVENTION

The present invention relates to a method for generating a reprojection panoramic view (RPV) from a dental DVT volume of a patient.

### BACKGROUND OF THE INVENTION

The mandibular canal is an important anatomical structure on each side of the mandible. Among other things, it encloses the mandibular nerve, damage to which can lead, for example, to paralysis of one side of the face. Therefore, it plays an important role in dental diagnostics and especially in the planning of surgical interventions in the mandibular region. The mandibular canal is patient-specific and can vary greatly in shape and course. Its shape is roughly tubular, although its cross-section may show considerable variation in shape and size along its course. Its course may also vary considerably: It can have straight courses in parts, but it can also have courses that are locally very bent.

DVT is ideally used to assess the mandibular canal anatomy, as it allows a geometrically accurate image of the anatomical structures in three dimensions. The clinician consults the DVT to follow the course of the mandibular canal and, for example, to assess its distance from other anatomical structures or possible implant positions. This enables the clinician to accurately and reliably plan procedures such as wisdom tooth extraction or implant placement.

The difficulty in efficiently assessing the mandibular canal is its curved course, which in addition runs often oblique to the orthogonal slices of the multiplanar reformation (MPR) of standard radiology display programs. Accurate tracking of the mandibular canal and its evaluation in all three spatial dimensions is therefore often associated with increased navigational effort.

One prior art solution to this problem is the use of so-called tilted MPR views or “custom sections”: In this case, a planar section is placed through the volume in such a way that it runs as tangentially as possible to the mandibular canal and thus maps a large part of the mandibular canal. However, due to the anatomically determined curvature of the mandibular canal, this is often not possible. In addition, the curvature means that the mandibular canal is only actually cut in the center of the view, for example, while it runs out of the slice at the edges of the view and is therefore no longer optimally displayed. Furthermore, manually setting the correct slice view is associated with navigation and time expenditure and requires a certain amount of practice.

### DISCLOSURE OF THE INVENTION

The inventors are not currently aware of any technique that automatically generates a patient-specific view aligned with the mandibular canal that allows the physician to efficiently assess the mandibular canal anatomy.

The objective of the present invention is to provide a method for automatically generating a reprojection panoramic view from a dental DVT volume of a patient, which is aligned with the course of the left and right mandibular canals (hereinafter collectively referred to as the mandibular canal).

This objective is achieved by the method according to claim 1. The subject-matter of the dependent claims relate to preferred embodiments or further developments.

The computer-implemented method according to the invention serves to automatically generate a reprojection panoramic view from a dental DVT volume of a patient, which is aligned with the course of the mandibular canal. The method comprises the following steps: localization of the mandibular canal, which is performed automatically or manually; automatic definition of a projection region of the RPV, which comprises the following sub steps: Automatically determining a guide curve in a plane perpendicular to the patient longitudinal axis based on the located mandibular canal; Automatically defining a variable or constant thickness profile along the guide curve; Extruding the area defined by the guide curve and thickness profile along the patient longitudinal axis; and generating the RPV by reprojecting the DVT volume in the defined projection region.

An advantageous effect of the invention is that it enables automatic alignment of the guide curve, which is optimized for applications involving the mandibular canal. This means that the physician no longer has to adjust the guide curve or work with a sub optimally aligned curve. This can save time and also increase the quality.

Thereby the guide curve is determined in such a way that, on the one hand, it is aligned with the mandibular canal (for example, by minimizing a distance dimension) and, on the other hand, it preferably preserves the esthetics of the resulting RPV (in particular, by avoiding local distortions and strong global asymmetries). As representation of the guiding curve, e.g., interpolating curves with freely selectable knot points, implicitly defined curves, or one of many predefined curve shapes (templates) which are then adapted by geometric transformations can be used. Other dental structures can be used to support the determination of the guide curve. Furthermore, the guide curve can be selected in such a way that it does not follow the sharp bend of the mandibular canal at the mental foramen, but continues in the direction of the anterior tooth region. The thickness profile of the projection area can be selected in different ways: e.g., proportional to the diameter thickness of the mandibular canal, constant, or vanishingly small. In the latter case, the RPV corresponds to a curved sectional view intersecting the mandibular canal approximately in the center. To localize the mandibular canal, prior knowledge can optionally be used, a trained machine learning method or classical image processing methods can be employed, or the mandibular canal can be drawn in by the user. The guide curve of the RPV can be used as a starting point for post navigation through the DVT volume, ensuring easy navigation along the mandibular canal in all 3D sectional views. The result of the mandibular canal localization can optionally be graphically displayed on the resulting RPV. Furthermore, those areas of the mandibular canal that are outside the projection region can be specially marked on the RPV (This is done by back-projecting these areas onto the RPV). If a machine learning method is used for the localization of the mandibular canal, it can be trained e.g., by data pairs comprising DVT volumes and associated segmentation masks, probability distributions, heat maps, center lines, point clouds, triangular grids, bounding boxes representing the mandibular canal.

### BRIEF DESCRIPTION OF THE DRAWINGS

In the subsequent description, the present invention will be explained in more detail by means of exemplary embodiments and with reference to the drawings, wherein

FIG. 1a—shows a typical prior art reprojection panoramic view generated from the projection region derived from the guide curve and thickness profile in FIG. 1b;

FIG. 1b—shows the guide curve from which the projection region for generating the reprojection panoramic view in FIG. 1a is derived, in a sectional plane perpendicular to the patient's longitudinal axis according to the state of the art;

FIG. 2—shows a projection region determined by linear extrusion of a guide curve according to the state of the art;

FIG. 3—shows a reprojection panoramic view optimized for the mandibular canal of the same DVT volume as in FIG. 1a, which was generated according to the present invention;

FIG. 4—shows a projection of the maximum intensities as well as a segmentation of the mandibular canal (white) on a sectional plane of the DVT volume perpendicular to the patient's longitudinal axis, where the black line indicates a guide curve according to the invention aligned with the mandibular canal, which is used to generate an RPV optimized for the mandibular canal.

FIG. 5—shows an RPV according to the invention optimized for the mandibular canal (a), which serves as a starting point for navigation through the volume; views (b-d) show the sectional planes tangential and perpendicular to the guide curve, which run through the mandibular canal due to the optimized placement of the guide curve and thus enable navigation along it.

FIG. 6—shows an RPV optimized for the mandibular canal according to the invention, on which the center line of the localized mandibular canal is drawn as a white line, whereby the dashed part in contrast to the solid part indicates that the mandibular canal is located outside the projection area here;

FIG. 7—shows a schematic diagram of an extraoral X-ray system according to one embodiment.

The reference numbers shown in the drawings designate the elements listed below, which are referred to in the following description of the exemplary embodiments.
1. Reprojection Panorama View (RPV)
2. Mandibular Canal
3. Projection region
4, 4′ Guide curve, curve
5. Patient longitudinal axis
6. Control points (knots)
7. Severe curvature of the mandibular canal at the mental foramen
8. DVT system
9. X-ray device
10. X-ray tube
11. X-ray detector
12. Control unit
13. Head fixation
14. Bite
15. Computer
16. Display
D: Thickness of the projection region (3) in a sectional plane perpendicular to the patient's longitudinal axis (5).

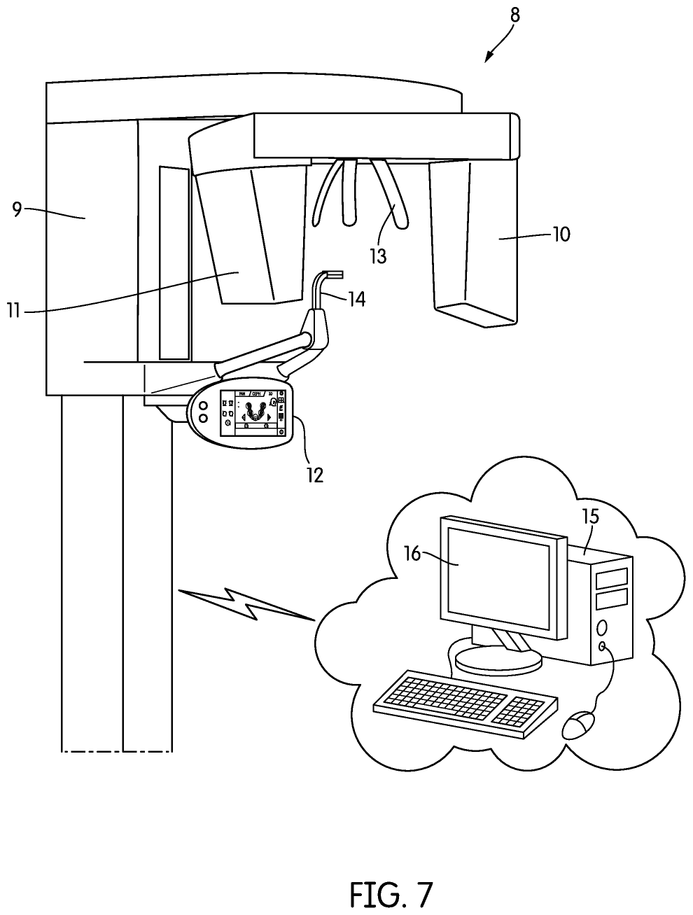

The method according to the present invention is a computer-implemented method and can be carried out on a computerized DVT system (8), as shown in an embodiment in FIG. 7. To this end, the present invention also includes a computer program having computer-readable code. The computer program can be provided on a storage medium. The computerized DVT system (8) comprises an X-ray device (9) for performing patient imaging, generating the X-ray images or a sinogram. The X-ray device (2) has an X-ray source (10) and X-ray detector (11), which are rotated around the patient's head during the recording. The trajectory of the X-ray source (10) and X-ray detector (11) during the recording can describe a circular path. Alternatively, it can assume a shape deviating from this. If several actuators are controlled simultaneously, a device trajectory around the patient's head that deviates from a pure circular path can be achieved. The patient's head is positioned in the X-ray device (9) with the bite (14) and the head fixation (13). The computerized DVT system (8) comprises a control unit (12), preferably a computer (15) or a computing unit that can be connected to the X-ray device (9), and preferably a display (16), inter alia to visualize the data sets. The computer (15) may be connected to the X-ray device (9) via a local area network (not shown) or alternatively via the Internet. The computer (15) may be part of a cloud. Alternatively, the computer (15) may be integrated into the X-ray device (9). The calculations may alternatively take place in the cloud. The computer (15) executes the computer program and provides the data sets, inter alia for visualization on the display (16). The display (16) may be spatially separated from the X-ray device (9). Preferably, the computer (15) can also control the X-ray device (9). Alternatively, separate computers (15) may be used for control and reconstruction.

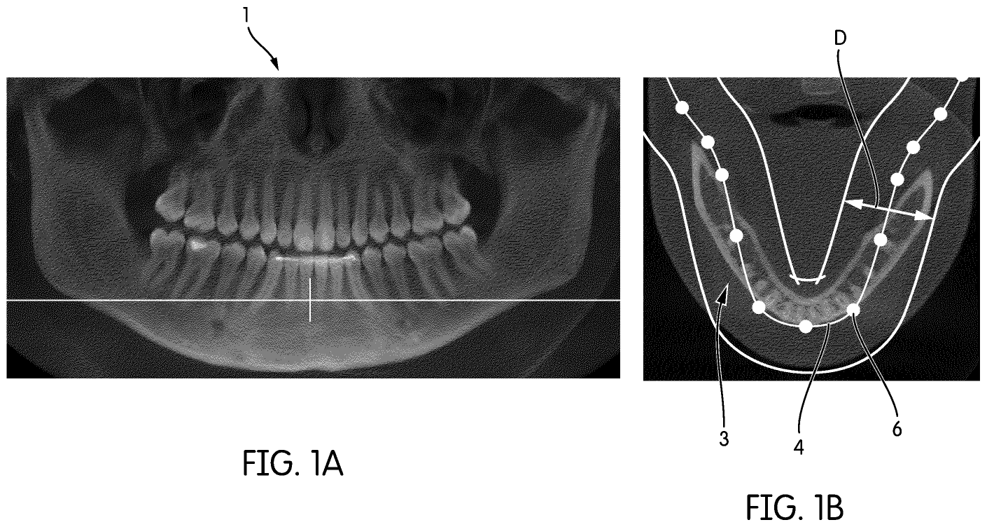

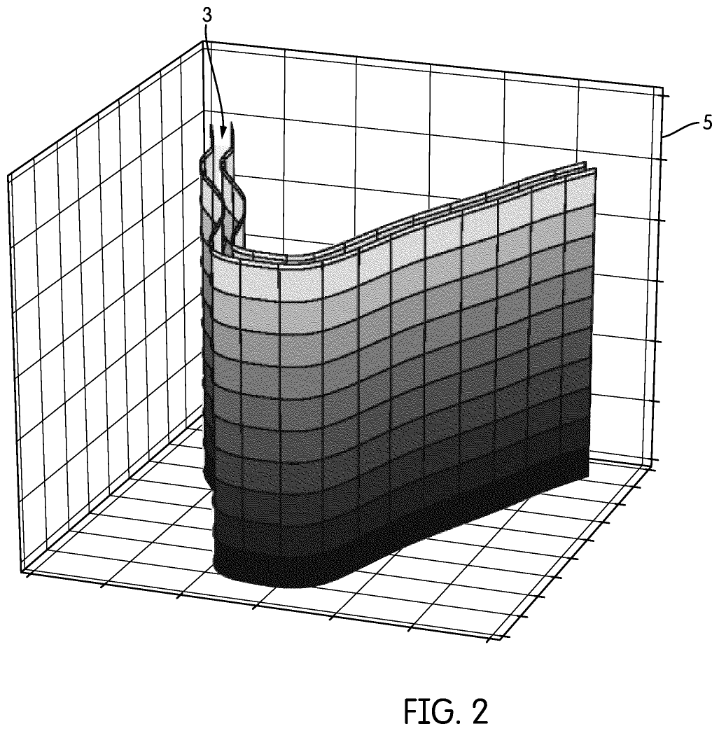

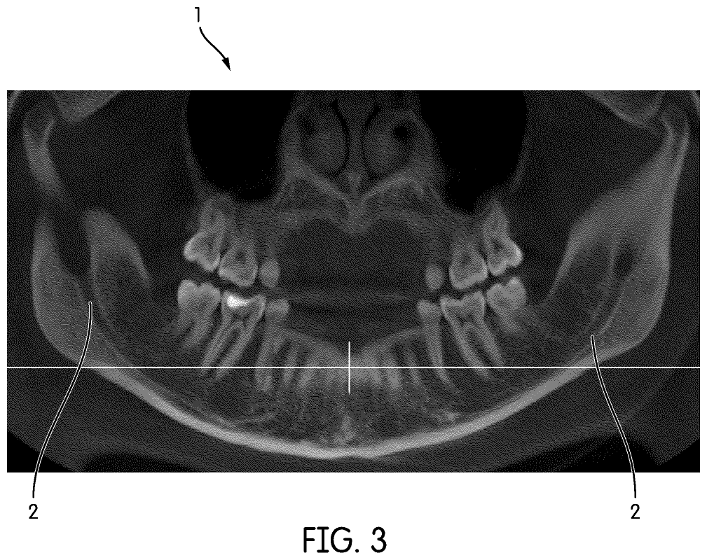

The method according to the invention is used to automatically generate a reprojection panoramic view (RPV) (1) from a dental DVT volume of a patient, which is aligned with the course of the mandibular canal (2) as shown in FIG. 3. FIG. 1A-B and FIG. 2 show comparative examples from the prior art to explain the invention. The method according to the invention comprises the following steps; (S1) Localization of the mandibular canal (2); (S2) Automatic definition of a projection region (3) of the RPV (1), which comprises the following sub steps: (S2.1) automatically setting a guide curve (4) in a plane perpendicular to the patient longitudinal axis (5) by means of the localized mandibular canal (2); (S2.2) automatically defining a variable or constant thickness profile along the guide curve (4); (S2.3) Extruding the area defined by guide curve (4) and thickness profile along the patient longitudinal axis (5); and (S3) Creating the RPV (1) by reprojecting the DVT volume in the defined projection region (3). The representation of the localized mandibular canal (2) in step (S1) can be, for example, a center line, a segmentation mask, a triangular grid as a surface mesh, a point cloud, or a heat map indicating a probability distribution.

In a preferred embodiment, the guide curve (3) is determined in step (S2.1) by means of an optimization with respect to a distance measure between the guide curve (4) and the localized mandibular canal (2), taking into account at least one of the following criteria:
Preservation of the esthetics of the resulting RPV (1), wherein at least one of the following criteria is taken as a measure of the esthetics: Avoidance of local distortions of the RPV (1) to be created in step (S3), Reduction of the recording-induced asymmetry of the RPV (1) to be created in step (S3);
In case of a guide curve (4) spanned by freely chosen control points (6), limitation of the curve complexity, which is determined by the number of control points (6) or degree of a polynomial.

Preferably, the guide curve (4) to be set has one of the following representations with associated optimization freedoms.
Curve (4′) defined by freely selectable control points (6) and an interpolation rule, where the positions of the control points (6) are the free optimization parameters;
curve (4′) selected from a set of predetermined curve forms and adapted under geometric transformations, where both the transformation parameters of the geometric transformations and the selection of the curve (4) from the predetermined set are optimized;
curve (4′) parameterized by a function, where the function parameters are the free optimization parameters.

If the representation of the mandibular canal (2) is a line in three-dimensional space, the preferred procedure is to project this line onto a plane perpendicular to the patient's longitudinal axis. The sum of the distances between points on the projected mandibular canal (2) and their closest points on the guide curve (4) serves as the distance measure to be minimized. This sum can be weighted, and the distances calculated by any distance metric, such as the Euclidean distance. In the case of a representation of the mandibular canal (2) as a three-dimensional heat map, for example, a centerline can be derived from the heat map and then can be proceeded as previously described. Alternatively, the three-dimensional heat map can be projected onto a plane perpendicular to the patient's longitudinal axis and viewed as a potential landscape within which the guide curve (4) is placed so that the total potential along the guide curve (4) is minimized.

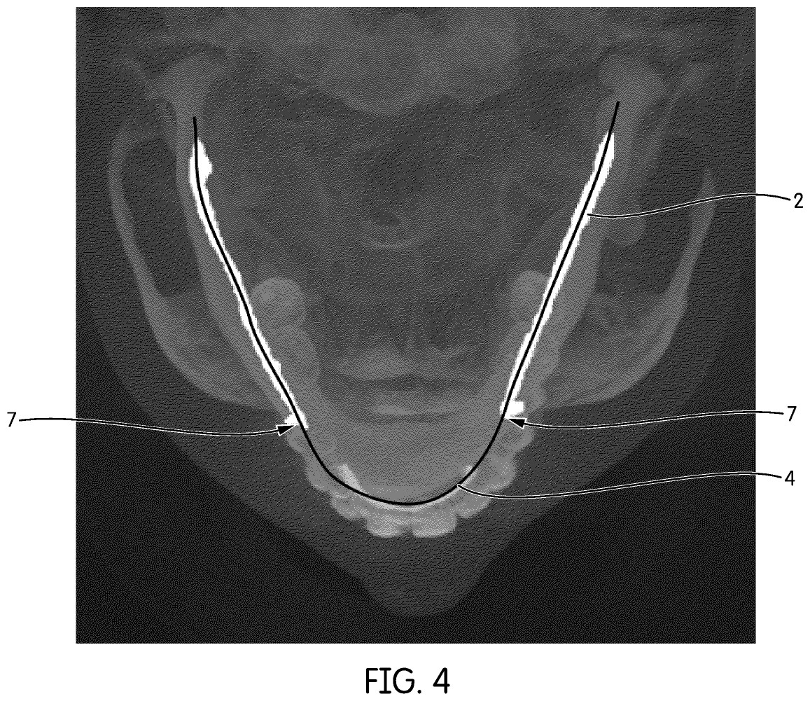

In a further preferred embodiment, in addition to the mandibular canal (2), other dental relevant structures can be taken into account to optimize the guide curve (4), which include at least one of the following: Teeth, Incisal point, Foramen Mandibulae, Foramen Mentale, Tuberculum Mentale, Protuberantia Mentalis, Foramen Lingualis, Spina Mentalis, Fossa Digastrica. These additional structures serve as orientation for the course of the guide curve (4) in regions where, due to the anatomy, there is no mandibular canal (2), such as in particular in the region of the tip of the chin between the mental foramina, from which the middle part of the RPV (1) is derived, as well as in the regions behind the mandibular foramina, from which the outer parts of the RPV (1) are derived. This has the effect that the guide curve (4) can be meaningfully bridged or continued in these regions (see FIG. 4). Preferably, the guide curve (4) is selected in such a way that it continues towards the tip of the chin at the point of sharp curvature of the mandibular canal at the mental foramen (7) (see FIG. 4), following the criteria of esthetics, whereby the detection of this point can be made either by consulting the positions of the above-mentioned mental foramina or on the basis of a curvature measure.

In a further preferred embodiment, the thickness profile in step (S2.2) results from determining for each point on the guide curve (4) a local thickness (D) that is proportionally adapted to the respective local diameter of the mandibular canal (2). The local diameter for a particular point on the guide curve (4) can be determined, for example, from the cross-section of the mandibular canal with that plane which is perpendicular to the guide curve (4) and passes through the particular point on the guide curve (4). The proportion between thickness and diameter can vary along the guide curve.

In another preferred embodiment, a constant thickness profile with such a small thickness (D) is selected that the resulting RPV (1) corresponds to a curved sectional view.

Preferably, the localization step (S1) comprises at least one of the following sub-steps:
(S1.1) Use of prior knowledge;
(S1.2) Manual localization by the physician using an input device;
(S1.3) Automatic image processing of the DVT volume;
(S1.4) Use of a trained machine learning method.

Prior knowledge in step (S1.1) can, for example, be the result of a partial or complete localization that has already taken place before. Alternatively, literature values or empirical values can be used as prior knowledge. As input means in step (S1.2), for example, a dedicated editor can be used, which, for example, allows the drawing of splines representing the center lines of the mandibular canal (2) by setting knot points.

For example, automatic image processing in step (S1.3) can apply operations such as filtering, thresholding, folding/convolutions, applications of Active Shape Models, etc. to existing image information such as gray values, edges, histograms, etc. to locate the mandibular channel (2).

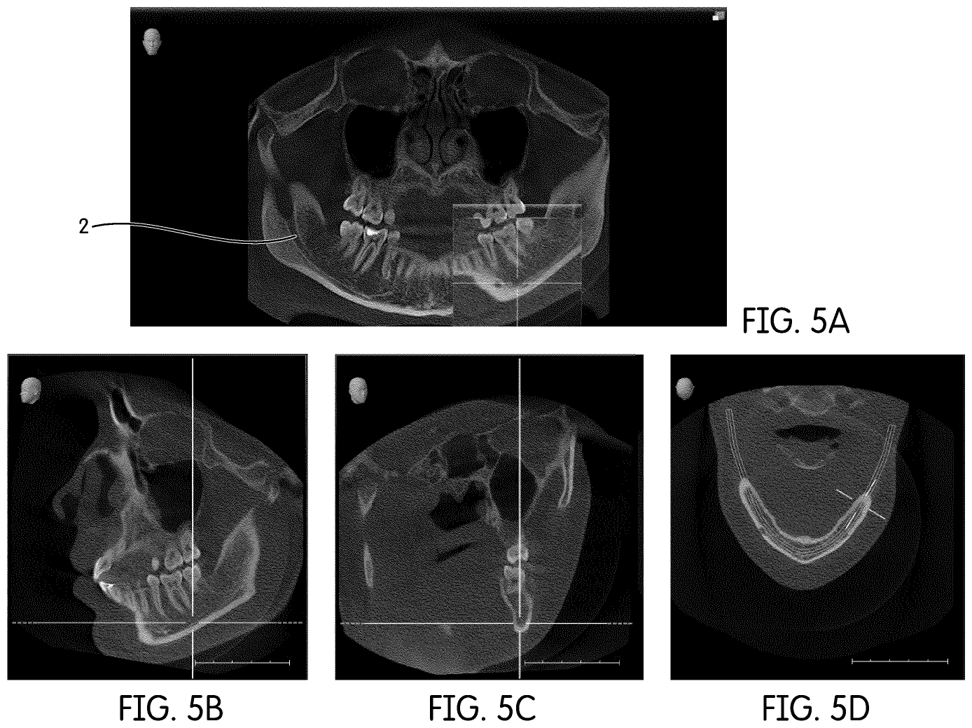

In a preferred embodiment, the projection region (3) of the RPV (1) optimized for the mandibular canal (2) serves as a starting point for navigation through the DVT volume to facilitate mandibular canal-specific workflows. For example, a common prior art dental-specific variant to navigate through the DVT volume is based on a multiplanar reformation (MPR) as shown in FIG. 5. The MPR is typically performed along the guide curve (4), which is also used to generate the RPV (1) as described above, resulting in the following layering:
perpendicular to the patient's longitudinal axis (axial direction, FIG. 5 bottom right)
perpendicular to axial direction and tangential to the guide curve (4) (longitudinal, FIG. 5 bottom left)
perpendicular to axial direction and perpendicular to the guide curve (4) (transversal, FIG. 5 bottom center).

Aligning the guide curve (4) with the mandibular canal (2) in accordance with the invention has the following effect: When navigating along the three layers described above, the mandibular canal is always the starting point and thus initially in focus. This facilitates work procedures for which the mandibular canal (2) is relevant, such as placing an implant, extracting teeth or other surgical procedures in the vicinity of the mandibular canal (2). Another variant to perform the layering of the DVT volume is a curved MPR (curved MPR), where the corresponding curve is also the guide curve (4) aligned with the mandibular canal (2) according to the invention. In this case, too, the mandibular canal (2) is the starting point for navigation.

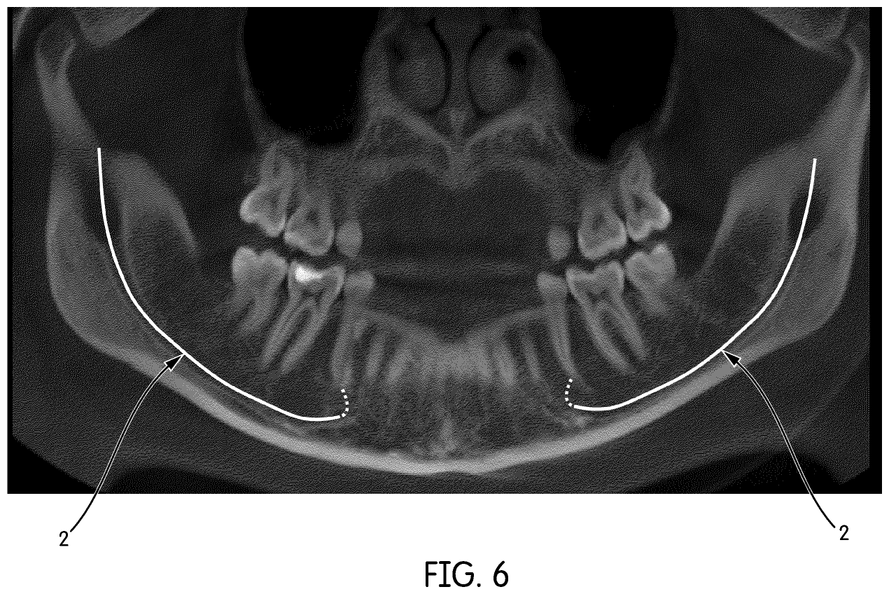

In a preferred embodiment, the result of the mandibular canal localization is displayed on the created RPV (1) (see FIG. 6).

Preferably, it is marked on the resulting RPV (1) where the localized mandibular canal (2) is located outside the projection region (3) (see dashed line in FIG. 6), for example by projecting the localization information of these regions back onto the RPV. This can be done, for example, by color or by shape/structure of the marking of the mandibular canal (2).

In a preferred embodiment, data pairs of DVT volumes and annotations are used in the localization step (S1.4) by means of machine learning for training, where these annotations have at least one of the following variants: segmentation masks, probability distributions, heat maps, center lines, point clouds, triangular grids, bounding boxes. An annotation here refers to the manual or automatic labeling of the structures to be learned in training on a DVT volume in one of the above variants.

According to the present invention, the data sets generated by the above embodiments may be presented to a physician for visualization, in particular for diagnostic purposes, preferably by means of the display (16) or a printout.

1. A method for automatically generating a reprojection panoramic view (RPV) from a dental DVT volume of a patient, which is aligned with the course of the mandibular canal, comprising the;
(S1) localizing the mandibular canal,
(S2) automatically defining a projection region of the RPV comprising:
(S2.1) Automatically setting a guide curve in a plane perpendicular to the patient longitudinal axis using the localized mandibular canal;
(S2.2) automatically defining a variable or constant thickness profile along the guide curve;
(S2.3) extruding an area defined by the guide curve and a thickness profile along the patient longitudinal axis; and
(S3) generating the RPV by reprojecting the DVT volume in the defined projection region.

2. The method according to claim 1, wherein the guide curve is determined in step (S2.1) using an optimization, which is performed with respect to a distance measure between the guide curve and the localized mandibular canal, taking into account at least one of the following criteria:
preservation of aesthetics of the resulting RPV, wherein a measure of aesthetics is based on at least one of the following criteria: avoidance of local distortions of the RPV to be generated in (S3), reduction of the recording-related asymmetry of the RPV to be generated in (S3);
In a case of the guide curve spanned by freely selected control points, limitation of a curve complexity, which is determined by the number of control points or degree of a polynomial.

3. The method according to claim 1, wherein the guide curve to be set has one of the following representations with associated optimization freedoms:
a curve which is defined by freely selectable control points and an interpolation rule, wherein the positions of the control points are free optimization parameters;
the curve which is selected from a set of predetermined curve forms and adapted under geometric transformations, wherein both transformation parameters of the geometric transformations and the selection of the curve from the predetermined set are optimized;
the curve which is parameterized through a function, wherein the function parameters represent free optimization parameters.

4. The method according to claim 1, wherein, in addition to the mandibular canal, further dental-relevant structures are added to optimize the guide curve, which include at least one of the following: Teeth, Incisal point, Foramen Mandibulae, Foramen Mentale, Tuberculum Mentale, Protuberantia Mentalis, Foramen Lingualis, Spina Mentalis, Fossa Digastrica.

5. The method according to claim 1, wherein the guide curve is selected such that it continues toward the tip of a chin at the point of severe curvature of the mandibular canal at an foramen mentale, and follows the criteria of aesthetics, wherein detection of this point is made either according to claim 4 or using a measure of curvature.

6. The method according to any of the preceding claims, wherein the thickness profile in step (S2.2) results from determining for each point on the guide curve a local thickness (D) proportionally adapted to the respective diameter of the mandibular canal.

7. The method according to claim 1, wherein a constant thickness profile with a small thickness (D) is selected such that the resulting RPV corresponds to a curved sectional view.

8. The method according to claim 1, wherein (S1) comprises at least one of the following:
(S1.1) use of prior knowledge;
(S1.2) manual localization by a physician using an input means;
(S1.3) automatic image processing of the DVT volume;
(S1.4) use of a trained machine learning method.

9. The method according to claim 1, wherein the projection region of the RPV optimized to the mandibular canal serves as a starting point for post navigation through the DVT volume to facilitate mandibular canal-specific workflows.

10. The method according to claim 1, wherein a result of a mandibular canal localization is shown on the created RPV.

11. The method according to any of the preceding claims, wherein a location is marked on the resulting RPV to show where the localized mandibular canal is located outside the projection region.

12. The method of claim 7, wherein data pairs of DVT volumes and annotations are used in (S1.4) for training, wherein said annotations comprises at least one of the following: segmentation masks, probability distributions, heat maps, center lines, point clouds, triangular grids, bounding boxes.

13. A non-transitory computer-readable storage medium, including instructions that when executed by a computer, cause the computer to:
(S1) localize the mandibular canal,
(S2) automatically define a projection region of the RPV comprising:
(S2.1) Automatically set a guide curve in a plane perpendicular to the patient longitudinal axis using the localized mandibular canal;
(S2.2) automatically define a variable or constant thickness profile along the guide curve;
(S2.3) extrude an area defined by the guide curve and a thickness profile along the patient longitudinal axis; and
(S3) generate the RPV by reprojecting the DVT volume in the defined projection region.

14. A computerized DVT system comprising an X-ray device a processor; and a memory storing instructions that, when executed by the processor, configure the apparatus to;
(S1) localize the mandibular canal,
(S2) automatically define a projection region of the RPV comprising:
(S2.1) Automatically set a guide curve in a plane perpendicular to the patient longitudinal axis using the localized mandibular canal;
(S2.2) automatically define a variable or constant thickness profile along the guide curve;
(S2.3) extrude an area defined by the guide curve and a thickness profile along the patient longitudinal axis; and
(S3) generate the RPV by reprojecting the DVT volume in the defined projection region.
